(19) United States
(12) Patent Application Publication
(10) Pub. No.: US 2003/0182226 A1
(43) Pub. Date: Sep. 25, 2003

(54) Direct credit/bank card reading through personal computers

(76) Inventor: Mary Suzanne Dougherty Goodman, Washington, DC (US)

Correspondence Address: ANN GOODMAN, 3254 O St. NW, WASHINGTON, DC, 20007, US

(21) Appl. No.: 10/041,842

(22) Filed: Mar. 19, 2002

(51) Int. Cl. G06F 17/60

(52) U.S. Cl. 705/38

(57) ABSTRACT

The change from what is existing to the use provided in this patent is the ability to use a debit/credit/bank card directly, physically, on any personal computer, whether at home or at the office, simply by swiping a device which would read directly the card without the need of the cardholder reading the numbers and typing them in one by one. A pin number or other method of identification may be used as deemed necessary by others. Currently, there is no way to use a debit/credit/bank card directly on personal computers, but only in supermarkets, drug stores, shops and service stations.

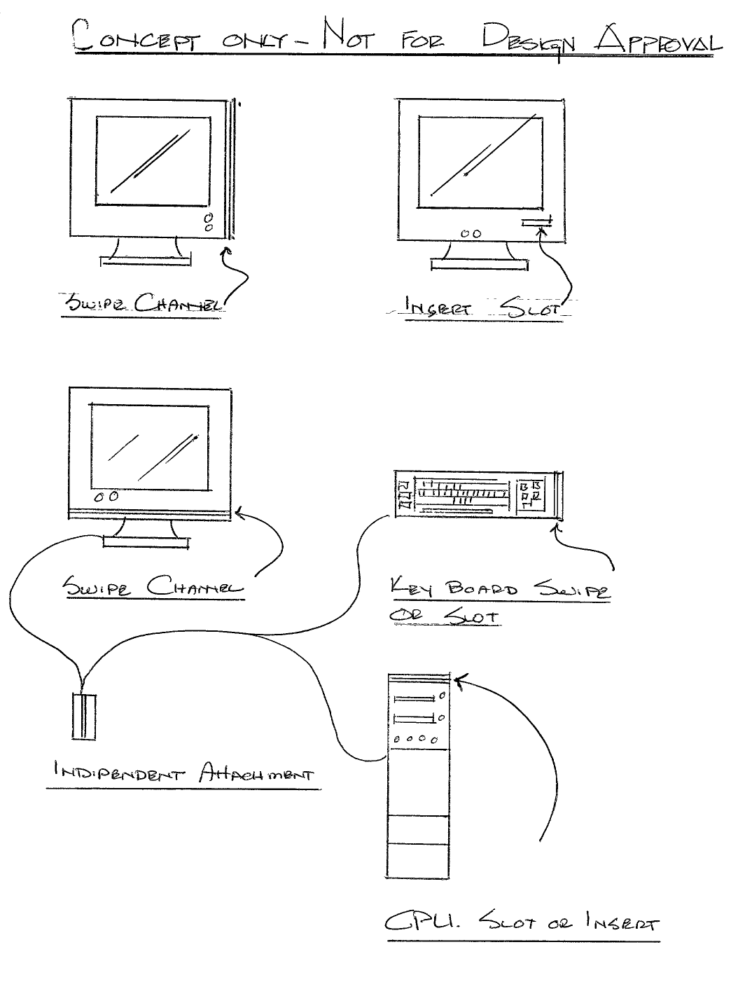

This devise would enable Internet shoppers the same simplicity of transaction as other providers of goods and services. It would encourage Internet shopping by making it fun and simpler to do while screening creditable buyers for Internet venders and service providers and eliminate the possibility of errors in reading the cards.

Any and all methods of processing credit/bank cards directly through personal computers including but not limited to using magnetic strips, with or without pin numbers, slot reads and scans. The technology needed to read a card via magnetic or other means is not included in this patent.

### BACKGROUND OF THE INVENTION

Field of Computer Science: Description of Prior Art. Currently, credit/bank card information is transferred into computers one number at a time by an individual reading of the card. This information is then read by a recipient of the Internet transmission who personally reads the card information and processes it through other means. This process would eliminate the necessity of the buyer from having to type his card into forms provided by the seller, one number at a time.

### GRIEF SUMMERY OF THE INVENTION

This use would allow the card holder to purchase things on any personal computer by using his credit/bank card directly in the computer without having to read the numbers on the card and type them into the computer himself.

This would be useful in, but not limited to, the following ways:

My husband's company holds conferences which would be greatly facilitated by allowing the participants to pay on line without having to type in the card, but by swiping it through a slot as in the supermarket.

Internet shopping and on line services would be made simpler.

### BRIEF DESCRIPTION OF THE SEVERAL VIEWS OF THE DRAWINGS

The drawings do not represent design patents but are only intended to indicate possible and obvious locations for implementing the above process. They include, but are not limited to, magnetic swipes or slots built within existing computer components such as monitors, modems, keyboards, main frames, etc., or accessory attachments which may also be adapted for existing computers. The drawings are not necessary to the patent.

### DETAILED DESCRIPTION OF THE INVENTION

This patent does not have further details but is a general patent which would need additional existing or new patents by patent holder or by others before implementation. This patent would require new technical design and patents which are yet to be designed if this utility patent is obtained. Various technical designs achieving the above use should not limit this patent. Existing cooperating parts such as magnetic credit/bank card scanners in supermarkets plus credit card telephone transfers to banks would likely be employed. All components needed in this use already exist but have not yet been combined for this purpose.

1. I claim to have invented the new and useful process of directly linking personal computers with the physical contact of credit/bank cards. This process would currently, but not limited to, involve adding magnetic card swipe scanner capabilities to typical computer components or accessories, as a broad industry standard. This claim is limited to the useful process of direct debit/credit/bank card reading as added to personal computers and not for any other aspect required in this process.
